(19) United States
(12) Patent Application Publication
(10) Pub. No.: US 2002/0105155 A1
(43) Pub. Date: Aug. 8, 2002

(54) Child wheeled vehicle

(76) Inventors: Chin-Jung Hou, Taichung (TW); Chih-Li Huang, Taichung (TW)

Correspondence Address: Chin-Jung Hou, 58, MA YUAN WEST ST., TAICHUNG, TW

(21) Appl. No.: 09/780,311

(22) Filed: Feb. 7, 2001

(51) Int. Cl. B62B 7/00; B62B 9/00

(52) U.S. Cl. 280/47.4

(57) ABSTRACT

A child wheeled vehicle includes a vehicle body, an operation bar, a push bar, and a braking device. The vehicle body includes a circular frame and a vibration-proof guard bar. A main frame has a front section provided with a foot tread plate and an upright pivot rod, a mediate section defining a receiving recess, and a rear section provided with two rear wheels and formed with a raised seat mounting portion for supporting a seat plate. The operation bar for controlling movement of the vehicle body has an upper section provided with a C-shaped bar, a mediate section pivoted with the pivot rod seat, and a lower section provided with a front wheel set. The push bar includes a sleeve section, a retractable section, and a locking member. The braking device includes a tread rod, a compression member, a snap ring, and a braking pad.

### BACKGROUND OF THE INVENTION

1. Field of the Invention

The present invention relates to a child wheeled vehicle, and more particularly to a child wheeled vehicle including a circular vehicle body that may be moved forward and backward by means of turning an operation bar leftward and rightward continuously, and movement of the vehicle body may be stopped by a braking device.

2. Description of the Related Prior Art

A conventional child wheeled vehicle does not have any protective device to efficiently protect the child seated on the seat plate of the child wheeled vehicle, so that the child is easily hurt when the child wheeled vehicle is hit or struck by a foreign article. In addition, when the child wheeled vehicle is moved on an inclined road, the child wheeled vehicle easily upsets. Further, the child wheeled vehicle does not have any braking device so that movement of the child wheeled vehicle is not easily stopped.

### SUMMARY OF THE INVENTION

The present invention has arisen to mitigate and/or obviate the disadvantage of the conventional child wheeled vehicle.

The primary objective of the present invention is to provide a child wheeled vehicle, wherein the circular frame and the vibration-proof guard bar of the vehicle body may be used to efficiently protect the child seated on the seat plate of the child wheeled vehicle when the vehicle body is hit or struck by a foreign object.

Another objective of the present invention is to provide a child wheeled vehicle, wherein when the vehicle body is disposed in an inclined state, the two auxiliary wheels (the diameter of the auxiliary wheel is smaller than that of the front wheel) rotatably mounted on the two sides of one end of the rectangular plate of the front wheel set may be used to support the vehicle body, thereby preventing the vehicle body from upsetting.

A further objective of the present invention is to provide a child wheeled vehicle, wherein the braking device can be used to stop movement of the moving vehicle body easily and quickly, while the anti-slip portion mounted on the bottom of the braking pad secured on the lower end of the tread rod of the braking device can increase the friction, thereby enhancing the braking effect of the braking device.

A further objective of the present invention is to provide a child wheeled vehicle, wherein if the child seated on the seat plate does not want to operate and move the vehicle body, the user may push the push bar to move the vehicle body forward, while the operation height of the push bar may be adjusted so as to fit the user's height.

In accordance with a first embodiment of the present invention, there is provided a child wheeled vehicle, comprising a vehicle body, an operation bar, a push bar, and a braking device, wherein,

the vehicle body, includes a circular frame, and a vibration-proof guard bar secured on an outer periphery of the circular frame, a main frame mounted on a center of the vehicle body and secured in the circular frame, the main frame has a rear section formed with a seat mounting portion for supporting and positioning a seat plate, at least one rear wheel is rotatably mounted on a bottom of the rear section of the main frame, a foot tread plate is secured on a front section of the main frame and mates with an inner rim of the circular frame, an upright pivot rod seat is mounted on the front section of the main frame, and a receiving recess is provided in a mediate section of the main frame;

the operation bar is used for controlling the vehicle body to move forward and backward, and has an upper section provided with a C-shaped bar, a mediate section pivoted with the pivot rod seat of the main frame, and a lower section provided with a front wheel set, the front wheel set includes a rectangular plate, two auxiliary wheels, and two front wheels, the two auxiliary wheels and the two front wheels are respectively rotatably mounted on two sides of two ends of the rectangular plate;

the push bar, has an operation height that may be adjusted according to a height of a user, and includes a sleeve section, a hollow retractable section, and a locking member, the hollow retractable section has a lower end slidably mounted in the sleeve section, for adjusting the operation height of the push bar, the locking member is used for locking the lower end of the hollow retractable section in the sleeve section;

the braking device, is received in and extended outward from the receiving recess of the mediate section of the main frame of the vehicle body, and includes a tread rod, a compression member, a snap ring, and a braking pad, the tread rod is movably passed through the receiving recess and has a top end provided with an action block, the compression member is mounted on the tread rod and urged between a bottom of the action block of the tread rod and a bottom wall of the receiving recess, the snap ring is secured on a mediate section of the tread rod and rested on a bottom of the meditate section of the main frame, and the braking pad is secured on a lower section of the tread rod, and has a bottom face provided with an anti-slip portion.

In accordance with a second embodiment of the present invention, the vehicle body is adapted to have a shape of a motorcycle, the front section of the main frame has two sides each provided with an L-shaped tread plate, the rear section of the main frame is provided with a V-shaped forked bracket, a hollow sleeve cylinder is transversely secured on a distal end of the forked bracket and has two ends each defining a plurality of insertion holes, two rear wheel rods are each movably mounted in a respective end of the hollow sleeve cylinder and are each provided with a compressible boss detachably inserted into one of the insertion holes, and wherein, when the compressible boss of each of the two rear wheel rods is inserted into the insertion hole located at an outer end of the hollow sleeve cylinder, a distance between the two rear wheel rods is increased, and when the compressible boss of each of the two rear wheel rods is inserted into the insertion hole located at an inner end of the hollow sleeve cylinder, the distance between the two rear wheel rods is decreased.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a child wheeled vehicle in accordance with a first embodiment of the present invention;

FIG. 2 is a rear plan view of the child wheeled vehicle as shown in FIG. 1;

FIG. 3 is a partially cut-away enlarged cross-sectional view of the child wheeled vehicle as shown in FIG. 2;

FIG. 4 is a schematic operational view of the braking device of the child wheeled vehicle as shown in FIG. 3 in use;

FIG. 5 is a perspective view of a child wheeled vehicle in accordance with a second embodiment of the present invention;

FIG. 6 is a bottom plan view of the child wheeled vehicle as shown in FIG. 5; and

FIG. 7 is a schematic operational view of the child wheeled vehicle as shown in FIG. 6.

### DETAILED DESCRIPTION OF THE INVENTION

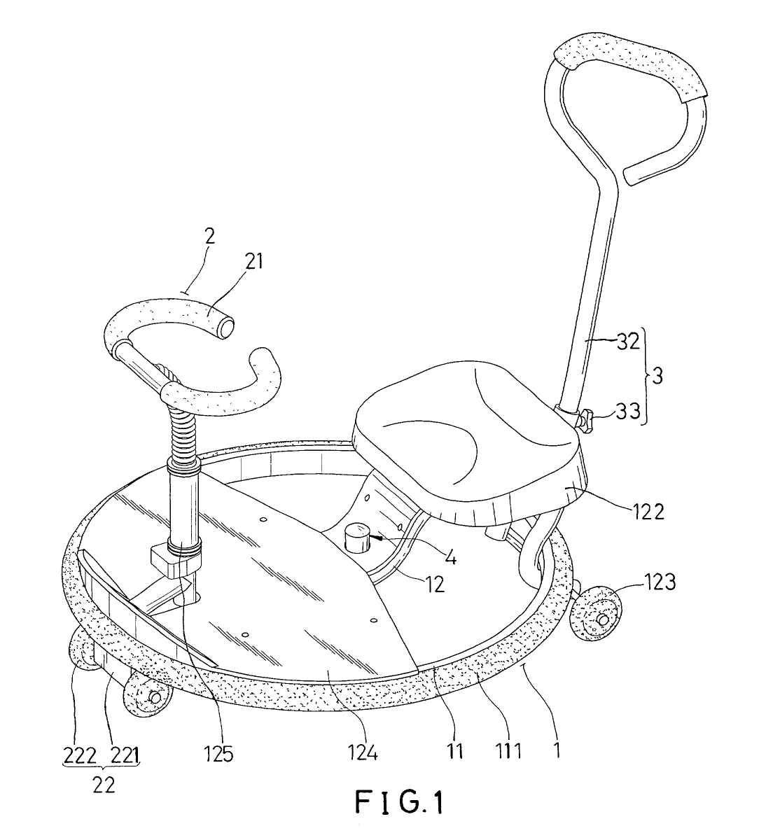

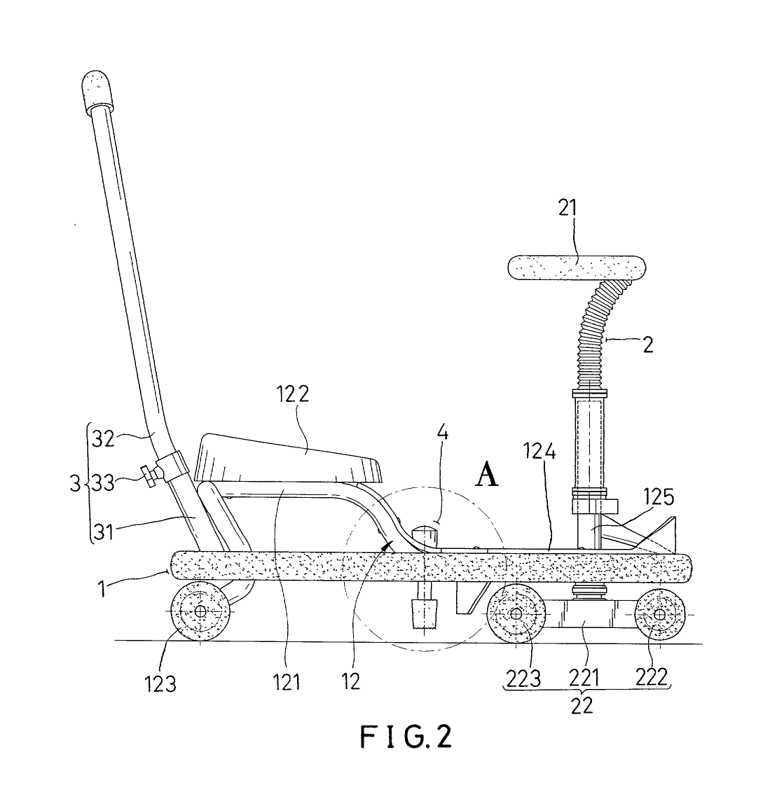

Referring to the drawings and initially to FIGS. 1-4, a child wheeled vehicle in accordance with a first embodiment of the present invention comprises a vehicle body 1, an operation bar 2, a push bar 3, and a braking device 4.

The vehicle body 1 includes a circular frame 11, and a vibration-proof guard bar 111 secured on the outer periphery of the circular frame 11. A main frame 12 is mounted on the center of the vehicle body 1 and is secured in the circular frame 11. The main frame 12 has a rear section formed with a seat mounting portion 121 for supporting and positioning a seat plate 122. At least one rear wheel 123 is rotatably mounted on the bottom of the rear section of the main frame 12. A foot tread plate 124 is secured on the front section of the main frame 12 and mates with the inner rim of the circular frame 11. An upright pivot rod seat 125 is mounted on the front section of the main frame 12, and a receiving recess 126 is provided in the mediate section of the main frame 12.

The operation bar 2 is used for controlling the vehicle body 1 to move forward and backward, and has an upper section provided with a C-shaped bar 21, a mediate section pivoted with the pivot rod seat 125 of the W main frame 11, and a lower section provided with a front wheel set 22.

The front wheel set 22 includes a rectangular plate 221, two auxiliary wheels 222, and two front wheels 223. The two auxiliary wheels 222 and the two front wheels 223 are respectively rotatably mounted on the two sides of the two ends of the rectangular plate 221.

The push bar 3 has an operation height that may be adjusted to mate with the height of a user, and includes a sleeve section 31, a hollow retractable section 32, and a locking member 33. The hollow retractable section 32 has a lower end slidably mounted in the sleeve section 31 for adjusting the operation height of the push bar 3. The locking member 33 is used for locking the lower end of the hollow retractable section 32 in the sleeve section 31.

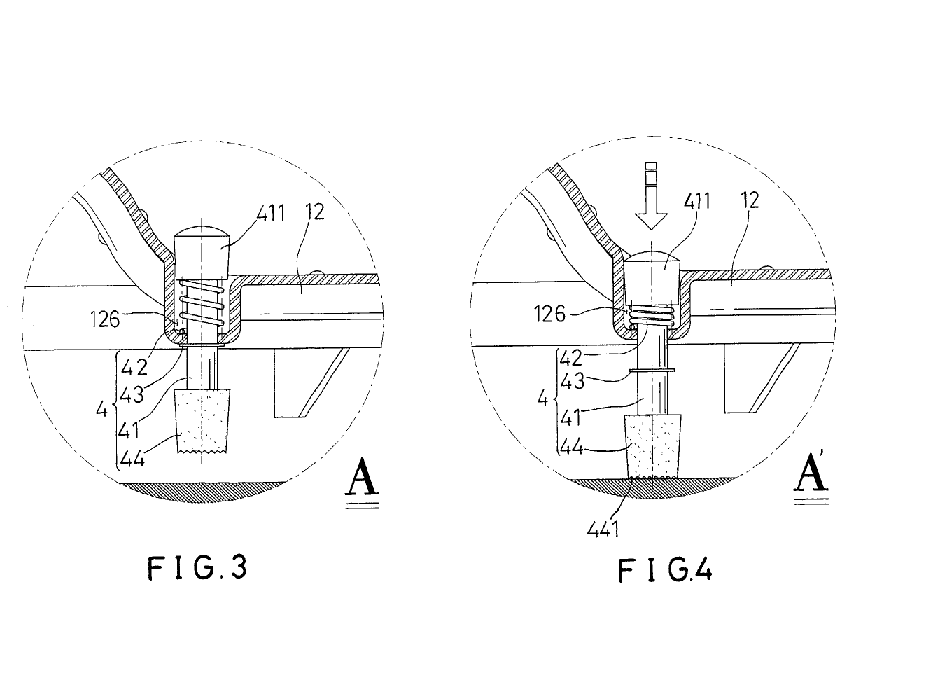

As shown in FIGS. 3 and 4, the braking device 4 is received in and extended outward from the receiving recess 126 of the main frame 11 of the vehicle body 1, and includes a tread rod 41, a compression member 42, a snap ring 43, and a braking pad 44. The tread rod 41 movably passes through the receiving recess 126 and has a top end provided with an action block 411. The compression member 42 is mounted on the tread rod 41 and is urged between the bottom of the action block 411 of the tread rod 41 and the bottom wall of the receiving recess 126. The snap ring 43 is secured on the mediate section of the tread rod 41 and is rested on the bottom of the meditate section of the main frame 12. The braking pad 44 made of rubber material is secured on the lower section of the tread rod 41, and has a bottom face provided with an anti-slip portion 441.

In operation, the child's hip may be seated on the seat plate 122 with his two feet placed on the tread plate 124, and with his two hands exerting a force of the C-shaped bar 21 of the operation bar 2. When the child exerts a rotational force to continuously turn the C-shaped bar 21 of the operation bar 2 rightward and then leftward, the two front wheels 223 located under the operation bar 2 are rotated matingly, so as to drive the vehicle body 1 to move.

If the child wishes to stop the vehicle body 1, he may step on the tread rod 41 of the braking device 4 to move downward by one of his feet, until the braking pad 44 located under the tread rod 41 touches the ground, thereby stopping movement of the vehicle body 1.

When the external force on the braking device 4 is removed, the tread rod 41 of the braking device 4 is returned to its original position by the restoring action of the compression member 42.

The user may also push the push bar 3 to move the vehicle body 1 forward. If the operation height of the push bar 3 does not fit the height of the user, the locking member 33 may be rotated to loosen the retractable section 32 so that the lower end of the retractable section 32 may be moved in the sleeve section 31, thereby freely adjusting the operation height of the push bar 3 so as to fit the user's height. The locking member 33 can then be rotated to actually lock the lower end of the retractable section 32 in the sleeve section 31.

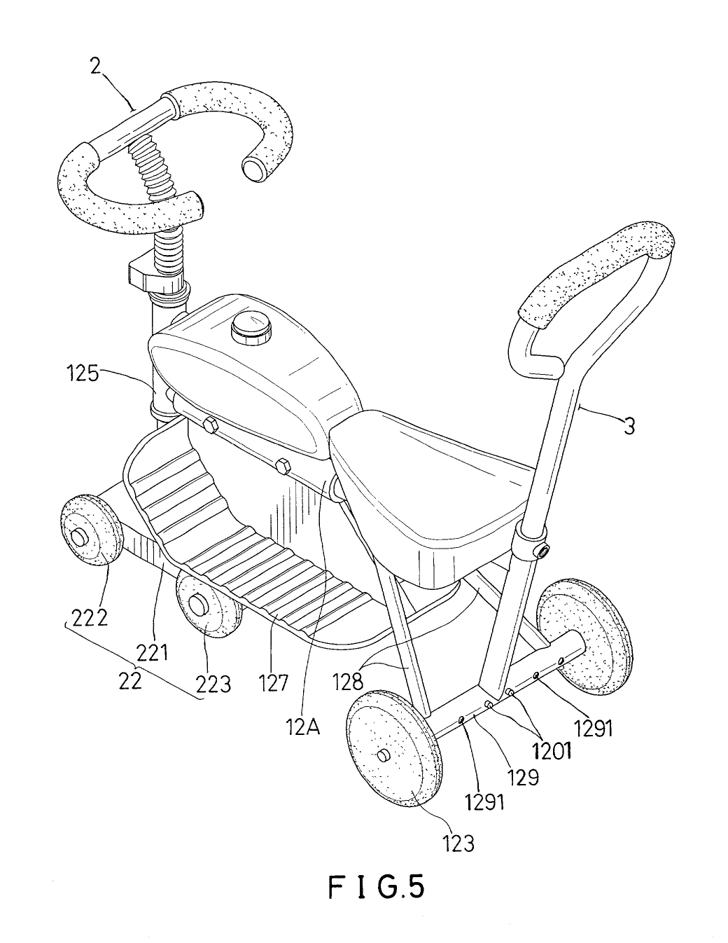

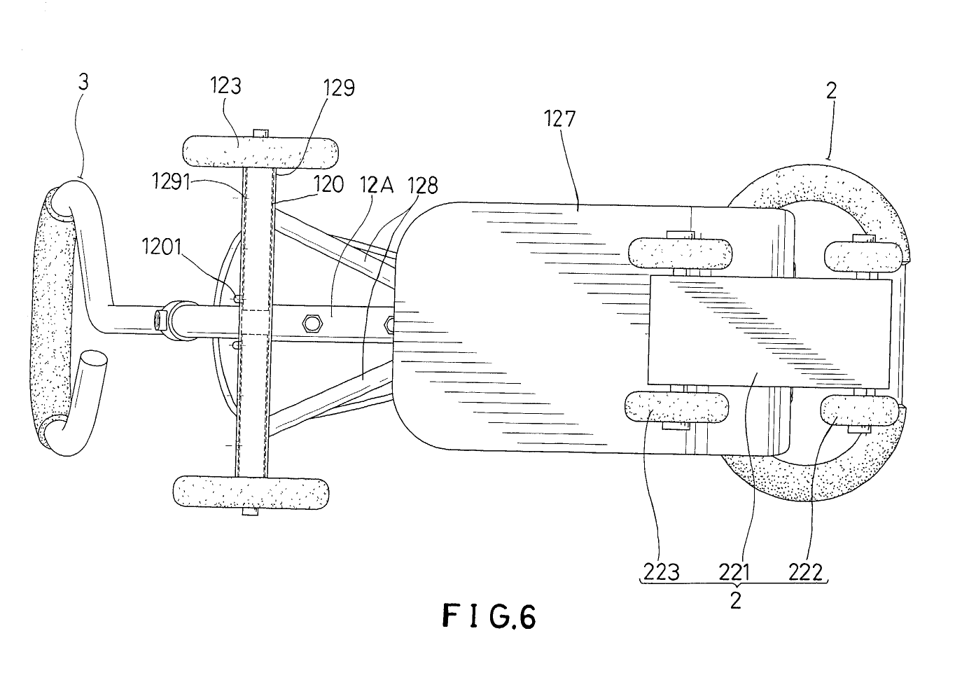

Referring to FIGS. 5-7, in accordance with a second embodiment of the present invention, the vehicle body 1 is adapted to have the shape of a motorcycle.

The main frame 12A whose front section is provided with a pivot rod seat 125, has two sides each provided with an L-shaped tread plate 127. The rear section of the main frame 12A is provided with a V-shaped forked bracket 128. A hollow sleeve cylinder 129 is transversely secured on the distal end of the forked bracket 128 and has two ends each defining a plurality of insertion holes 1291. Two rear wheel rods 120 are each movably mounted in a respective end of the hollow sleeve cylinder 129 and are each provided with a compressible boss 120 detachably inserted into one of the insertion holes 1291.

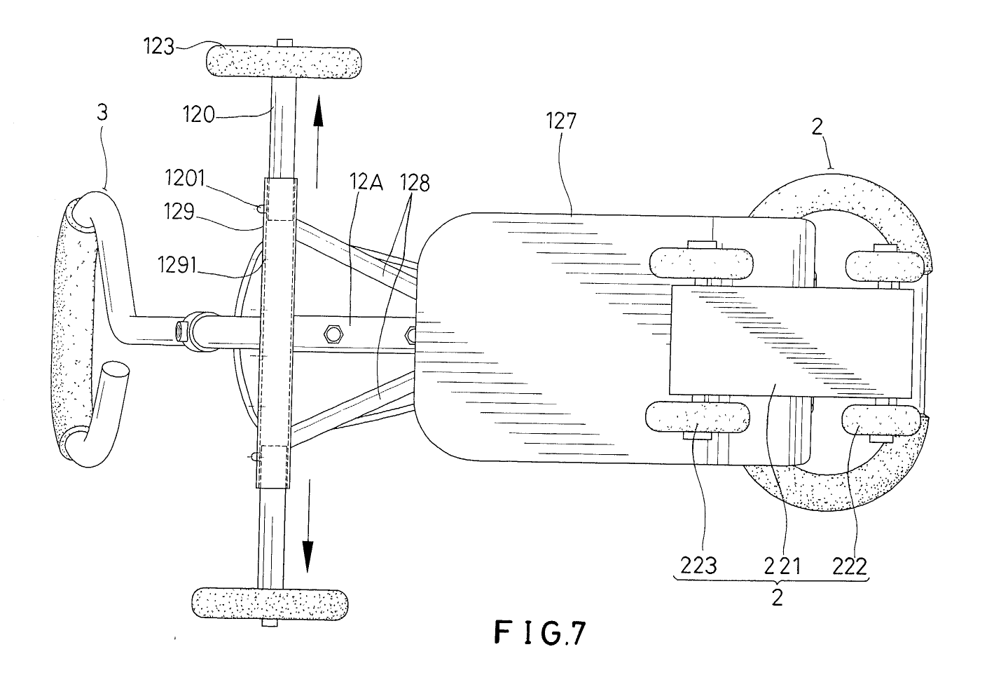

By such an arrangement, when the compressible boss 120 of each of the two rear wheel rods 120 is inserted into the insertion hole 1291 located at an outer end of the hollow sleeve cylinder 129 as shown in FIG. 7, the distance between the two rear wheel rods 120 is increased, and when the compressible boss 120 of each of the two rear wheel rods 120 is inserted into the insertion hole 1291 located at an inner end of the hollow sleeve cylinder 129 as shown in FIG. 6, the distance between the two rear wheel rods 120 is decreased.

Accordingly, the child wheeled vehicle in accordance with the present invention has the following advantages.

1. The circular frame 11 and the vibration-proof guard bar 111 of the vehicle body 1 may be used to efficiently protect the child seated on the seat plate 122 of the child wheeled vehicle when the vehicle body 1 is hit or struck by a foreign object.

2. When the vehicle body I is disposed in an inclined state, the two auxiliary wheels 222 (the diameter of the auxiliary wheel 222 is smaller than that of the front wheel 223) rotatably mounted on the two sides of one end of the rectangular plate 221 of the front wheel set 22 may be used to support the vehicle body 1, thereby preventing the vehicle body 1 from upsetting.

3. The braking device 4 can be used to stop movement of the moving vehicle body I easily and quickly, while the anti-slip portion 441 mounted on the bottom of the braking pad 44 secured on the lower end of the tread rod 41 of the braking device 4 can increase the friction, thereby enhancing the braking effect of the braking device 4.

4. If the child seated on the seat plate 122 does not want to operate and move the vehicle body 1, the user may push the push bar 3 to move the vehicle body 1 forward, while the operation height of the push bar 3 may be adjusted so as to fit the user's height.

Although the invention has been explained in relation to its preferred embodiment as mentioned above, it is to be understood that many other possible modifications and variations can be made without departing from the scope of the present invention. It is, therefore, contemplated that the appended claims will cover such modifications and variations that fall within the true scope of the invention.

What is claimed is:

1. A child wheeled vehicle, comprising a vehicle body (1), an operation bar (2), a push bar (3), and a braking device (4),
wherein,
said vehicle body (1), includes a circular frame (11), and a vibration-proof guard bar (111) secured on an outer periphery of said circular frame (11), a main frame (12) mounted on a center of said vehicle body (1) and secured in said circular frame (11), said main frame (12) has a rear section formed with a seat mounting portion (121) for supporting and positioning a seat plate (122), at least one rear wheel (123) is rotatably mounted on a bottom of said rear section of said main frame (12), a foot tread plate (124) is secured on a front section of said main frame (12) and mates with an inner rim of said circular frame (11), an upright pivot rod seat (125) is mounted on said front section of said main frame (12), and a receiving recess (126) is provided in a mediate section of said main frame (12);
said operation bar (2) is used for controlling said vehicle body (1) to move forward and backward, and has an upper section provided with a C-shaped bar (21), a mediate section pivoted with said pivot rod seat (125) of said main frame (11), and a lower section provided with a front wheel set (22), said front wheel set (22) includes a rectangular plate (221), two auxiliary wheels (222), and two front wheels (223), said two auxiliary wheels (222) and said two front wheels (223) are respectively rotatably mounted on two sides of two ends of said rectangular plate (221);
said push bar (3), has an operation height that may be adjusted according to a height of a user, and includes a sleeve section (31), a hollow retractable section (32), and a locking member (33), said hollow retractable section (32) has a lower end slidably mounted in said sleeve section (31), for adjusting said operation height of said push bar (3), said locking member (33) is used for locking said lower end of said hollow retractable section (32) in said sleeve section (31);
said braking device (4), is received in and extended outward from said receiving recess (126) of said mediate section of said main frame (11) of said vehicle body (1), and includes a tread rod (41), a compression member (42), a snap ring (43), and a braking pad (44), said tread rod (41) is movably passed through said receiving recess (126) and has a top end provided with an action block (411), said compression member (42) is mounted on said tread rod (41) and urged between a bottom of said action block (411) of said tread rod (41) and a bottom wall of said receiving recess (126), said snap ring (43) is secured on a mediate section of said tread rod (41) and rested on a bottom of said meditate section of said main frame (12), and said braking pad (44) is secured on a lower section of said tread rod (41), and has a bottom face provided with an anti-slip portion (441).

2. The child wheeled vehicle in accordance with claim 1, wherein said vehicle body is adapted to have a shape of a motorcycle, said front section of said main frame has two sides each provided with an L-shaped tread plate, said rear section of said main frame is provided with a V-shaped forked bracket (128), a hollow sleeve cylinder (129) is transversely secured on a distal end of said forked bracket (128) and has two ends each defining a plurality of insertion holes (1291), two rear wheel rods (120) are each movably mounted in a respective end of said hollow sleeve cylinder (129) and are each provided with a compressible boss (120) detachably inserted into one of said insertion holes (1291), and wherein, when said compressible boss (120) of each of said two rear wheel rods (120) is inserted into said insertion hole (1291) located at an outer end of said hollow sleeve cylinder (129), a distance between said two rear wheel rods (120) is increased, and when said compressible boss (120) of each of said two rear wheel rods (120) is inserted into said insertion hole (1291) located at an inner end of said hollow sleeve cylinder (129), the distance between said two rear wheel rods (120) is decreased.
